(19) United States
(12) Patent Application Publication
(10) Pub. No.: US 2019/0145157 A1
(43) Pub. Date: May 16, 2019

(54) INTEGRAL ANTISEISMIC DOOR FRAME

(71) Applicant: INVESNOVA SPA, Peñaflor (CL)

(72) Inventor: Nelson DIAZ FERRER, Santiago (CL)

(21) Appl. No.: 16/304,462

(22) PCT Filed: May 26, 2017
(86) PCT No.: PCT/CL2017/000014

§ 371 Date: Nov. 26, 2018

(30) Foreign Application Priority Data
May 26, 2016 (CL) 1279-2016

(51) Int. Cl. E06B 5/10; E06B 1/52

(52) U.S. Cl. CPC E06B 5/10; E06B 1/52

(57) ABSTRACT

The present invention relates to an integral antiseismic door frame or seismic shock dissipation door frame adaptable to climate changes, which controls movements for all types of vertical or horizontal communicational involvement on foot within a dwelling, either house or building for general use. The door frame is composed of a plurality of components having different geometrical shapes, masses, densities and elasticities, joined together to form an energy dissipater or force damper in an integral frame comprising one or more multidirectional energy dissipaters which are assembled perpendicularly thereto. During installation it can be adapted to variations in the parallelism of the side and top walls when anchoring thereto due to other elements made either of wood, plastic, iron or the like, which are installed lengthwise to increase its width and correct the parallelism of the walls, if necessary, without altering its energy dissipation properties. The components integrated in the integral door frame interact with each other, dissipating the energy exerted by the walls on the door, controlling loads, movements and deformations, maintaining normal operation of the door, preventing the obstruction thereof and at the same time jamming of the lock, such that it is possible to open the door during and after a seism or earthquake or when the door is affected by changes in the relative humidity of the environment.

The present invention relates to an integral antiseismic door frame or seismic shock dissipation door frame adaptable to climate changes, which controls movements for all types of vertical or horizontal on foot communicational involvement within a dwelling, either house or building for general use. The door frame is composed of a plurality of components having different geometrical shapes, masses, densities and elasticities, joined together to form an energy dissipater or force damper in an integral frame comprising one or more multidirectional energy dissipaters which are assembled perpendicularly thereto. During installation it can be adapted to variations in the parallelism of the side and top walls when anchoring thereto due to other elements made either of wood, plastic, iron or the like, which are installed lengthwise to increase the width of the frame and correct the parallelism of the walls, if necessary, without altering the energy dissipation properties.

Said elements integrated in the integral door frame interact with each other to dissipate the energy exerted by the walls on the door and control the loads, movements and deformations owing to a mass, density and elasticity differential, thus managing to keep the door working normally and preventing obstruction thereof and at the same time preventing jamming of the lock. Hence the door can be opened during and after a seism or earthquake or when the door is affected by changes in the relative humidity of the environment.

Frequently nowadays doors are deformed or become out of plumb with telluric movements due to the displacement of the walls, which apply loads on the frame, the latter doing the same on the door, thus producing jamming and/or blocking of the lock or door opening system. Conversely, opening of the door can be affected by expansion due to changes in the relative humidity of the environment as it acts on the size of the door and compresses its edges over the frame in several places.

The force applied in these places is dissipated through the integral frame, preventing the door lock from jamming and/or blocking, a problem which is solved by the present solution in an effective way, keeping the transit or evacuation route operational.

The objective of the present invention is to control and dissipate the structural deformation and displacements of the wall which have an effect on the opening of the door during an earthquake and to control the obstruction of the door when it is affected by seasonal climate changes or changes in the relative humidity of the environment which cause an expansion or contraction of the door and press it against the frame. Therefore, the invention will prevent a user from getting trapped inside the dwelling and will not to affect the operation of the door as it frequently occurs nowadays. Moreover, the door frame of the invention can be adapted to variations or loss of uniformity of the walls at the moment of anchoring thereto, since many times the walls are not left perfectly perpendicular. For this purpose a parallelism correction element is included in the present invention, like a wedge that comes pre-perforated to concentrically fit together with the integral frame parts without altering the mechanical qualities previously mentioned, the function of this element being the correction of said variations at the moment of installation.

To improve all the existing shortcomings, an integral door frame system has been configured, which is adaptable to climate changes and controls displacements, the door frame provided with a plurality of controlled deformation energy dissipation parts which absorb the displacements and dissipate the forces as it is in direct contact with the loads that the walls exert on a door or on the frame, controlling and absorbing displacements and preventing out of plumbing and the destruction of the door.

With regard to the state of the art, to avoid obstruction of the door we can cite the Antiseismic Door Frame of Chilean Application No. 201302355, which is a rigid energy dissipating system and not an independent energy dissipater. It only works in the X and Y planes, it interacts with the door and frame in a hinged manner and requires a plurality of independent parts for it to work. Blocking of the door is prevented with a different technology as it is composed of a plurality of independent separate elements which converge in a male and female U configuration and an intermediate energy dissipater, with the characteristic that it does not maintain the geometric configuration of the frame, necessitating a different span, doorway or installation zone, thereby requiring intervening the wall. Another feature of this Antiseismic Door Frame is that the inside frame needs to be in direct contact with the floor through an energy dissipater as an essential element for the operation of the energy dissipation system. It is not adaptable to climate changes, either, since the inside frame thereof is rigid and of a single piece, further not permitting correction of the parallelism of the walls.

It should be noted that the integral frame's configuration fulfils the resistance and fracture requirements currently in force, as it has the same dimensions and shape as the current frames and also, with respect to those previously mentioned, the same pre-disposition of the anchor guiding perforations.

These energy dissipation characteristics allow the device to only operate under large loads, thus remaining working normally under regular conditions.

### DESCRIPTION OF THE DRAWINGS

To better understand the integral antiseismic door frame or seismic shock dissipation door frame of the invention, which prevents obstruction during and after an earthquake and due to the effects of climate, the same will be described according to the drawings that form an integral part of the invention while not limiting or restricting modifications that may emerge in an obvious way, wherein:

FIG. 1 consists of an isometric parts diagram or exploded view between the interaction of the wall, the integral antiseismic door frame, the door and the wall parallelism correction element.

FIG. 2 consists of an isometric parts diagram of the head jamb and the side jambs of the same length of the integral door frame.

FIG. 3 shows an exploded and detailed perspective isometric view of the head jamb and the elements it comprises.

FIG. 4 shows an exploded and detailed perspective isometric view of the side jamb and the elements it comprises.

FIG. 5 shows an exploded and detailed perspective isometric view of the multidirectional energy absorption element and the insert or bushing located at its longitudinal axis.

FIG. 6 shows a detailed and perspective isometric view of the single injected piece head jamb and the zones it comprises.

FIG. 7 shows a detailed and perspective isometric view of the single injected piece side jamb and the zones it comprises.

FIG. 8 consists of a detailed isometric view of the head jamb and side jambs of the same length with the wall parallelism correction element of the integral door frame.

### DESCRIPTION OF THE INVENTION

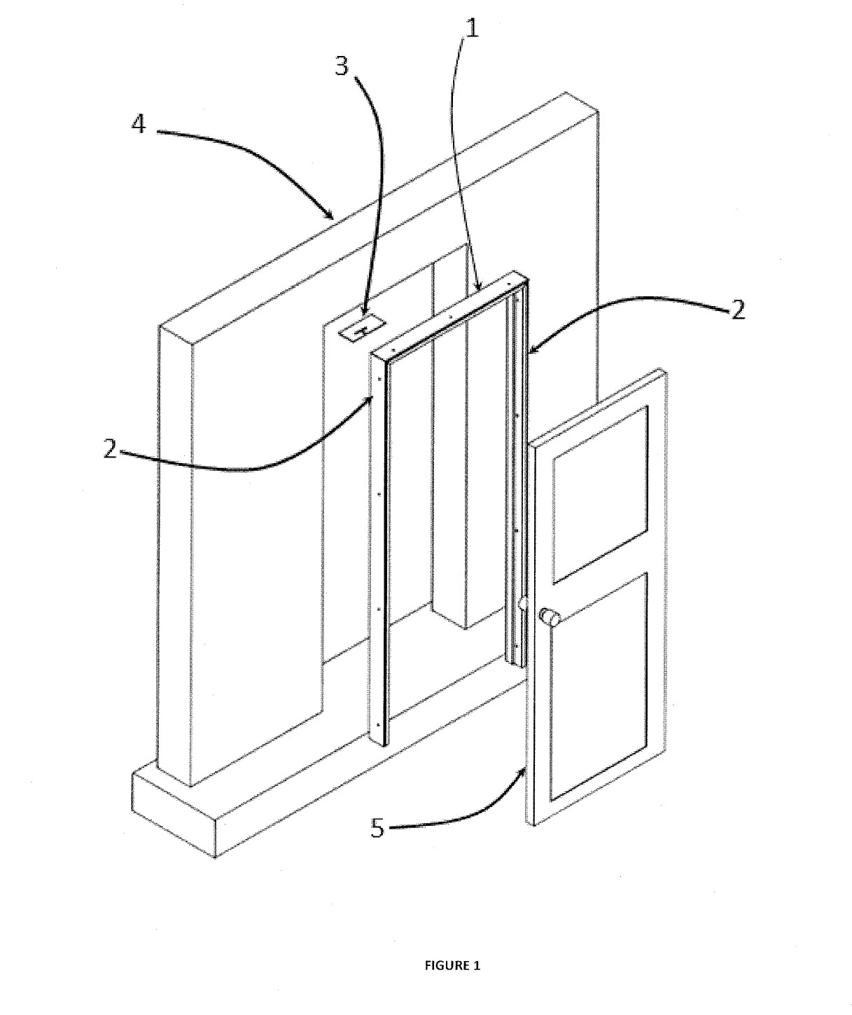

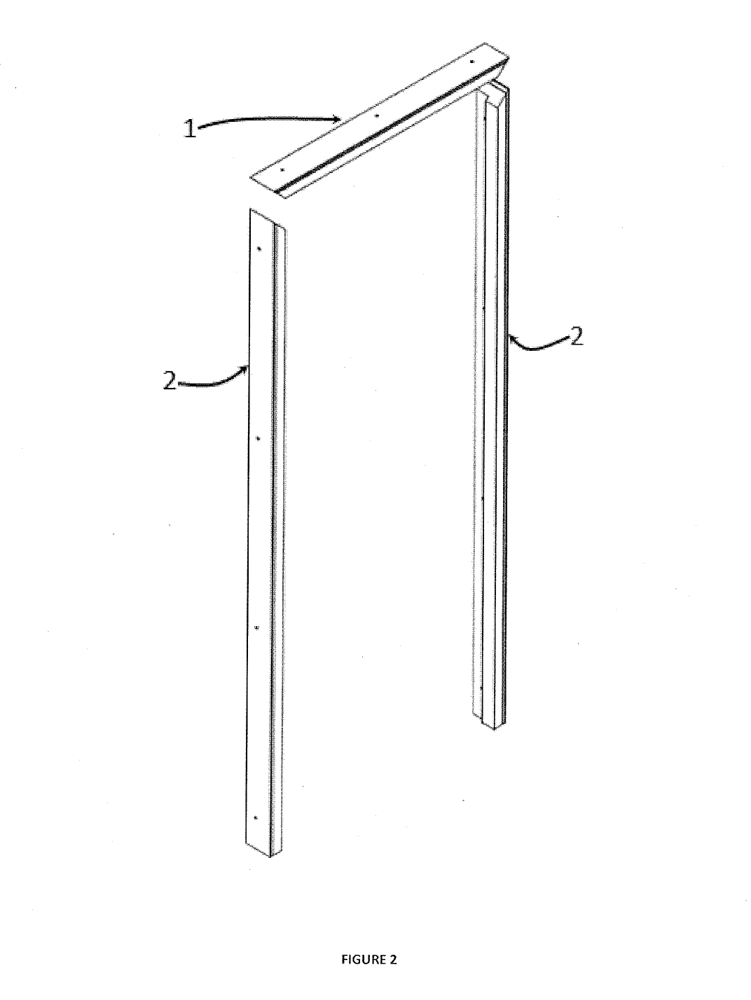

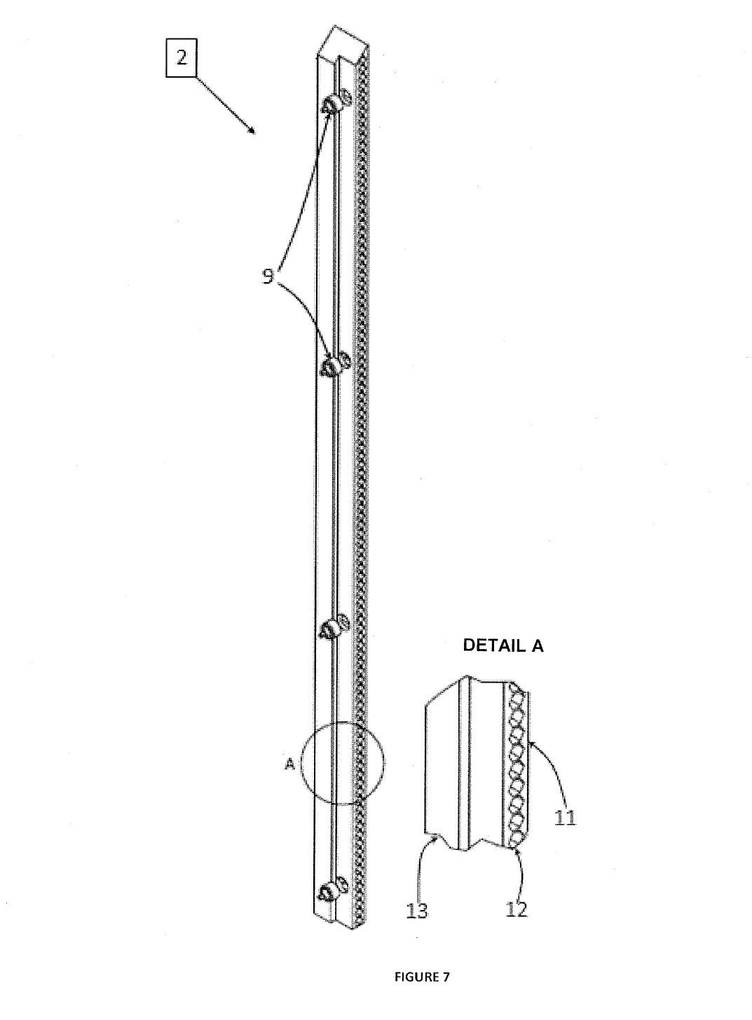

FIGS. 1 to 8 describe an integral antiseismic door frame or seismic shock dissipation door frame, either in a dwelling, house or building. The present invention refers to an integral antiseismic door frame or seismic shock dissipation door frame comprised of a plurality of elements of different geometrical shapes, masses, densities and elasticities joined together. The door frame may also be configured as a single injected piece characterized by zones. The door frame is comprised of a head jamb (1) and two side jambs (2) of the same length which control the movements and loads exerted by the wall on the door (see FIG. 2).

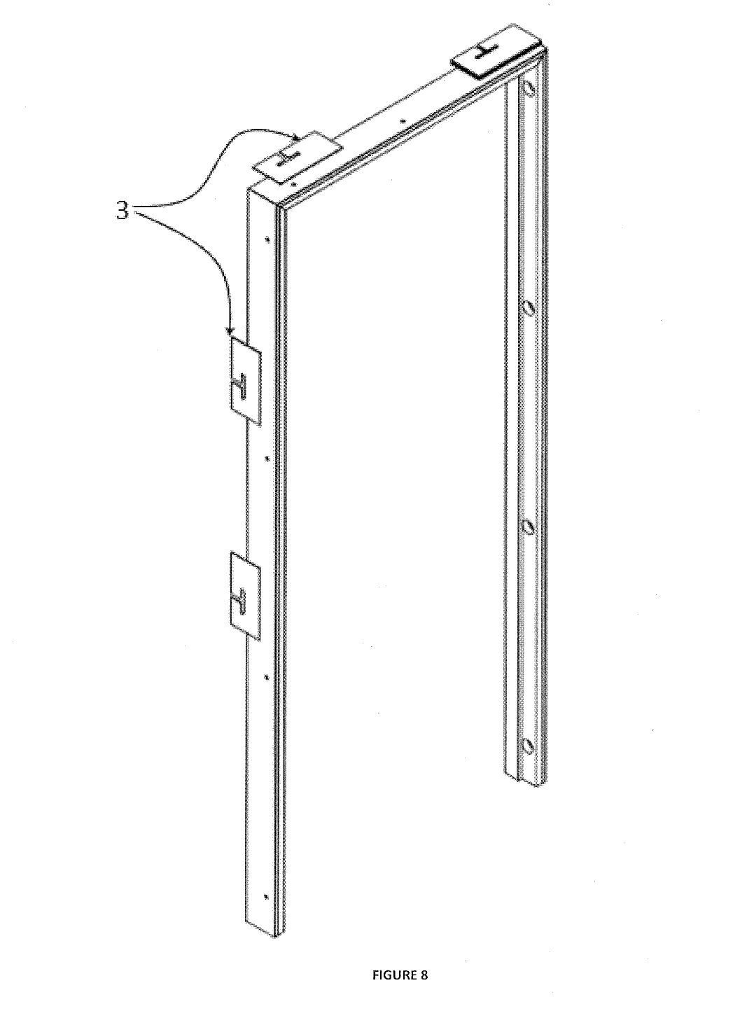

In the door frame, the jambs (1, 2) have one or more parallelism correction elements (see FIG. 8).

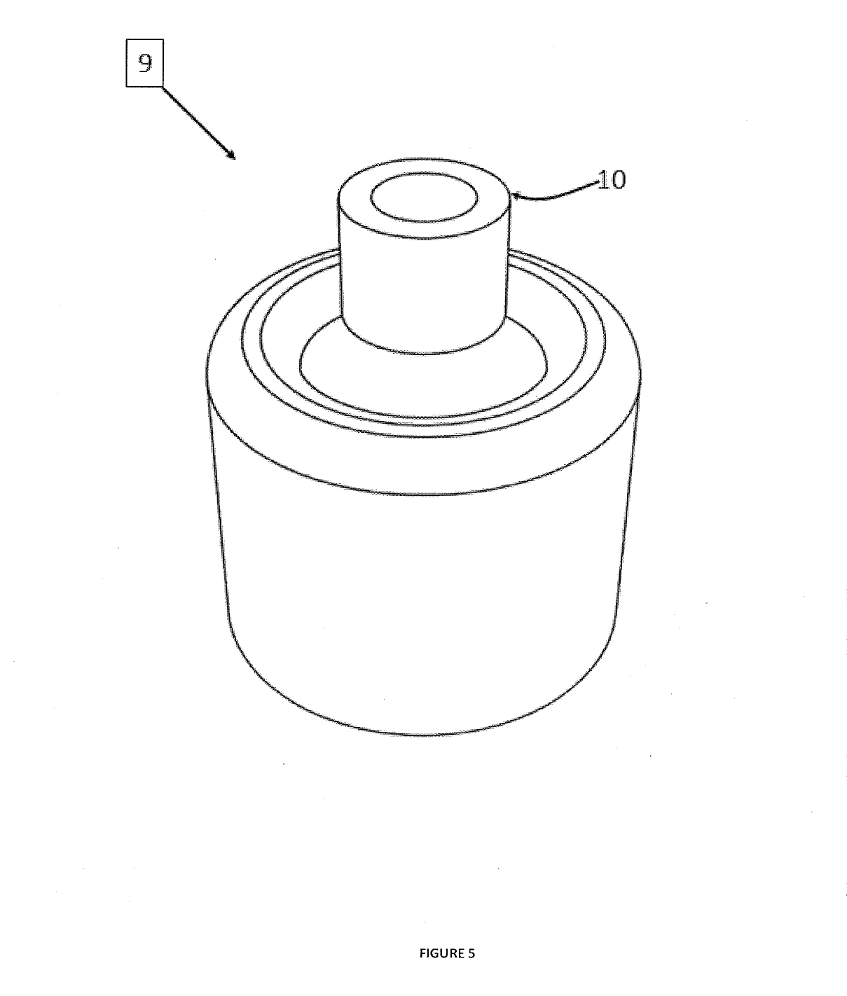

In the integral door frame, there is inserted a multidirectional energy dissipater (9) at its longitudinal axis (see FIG. 5).

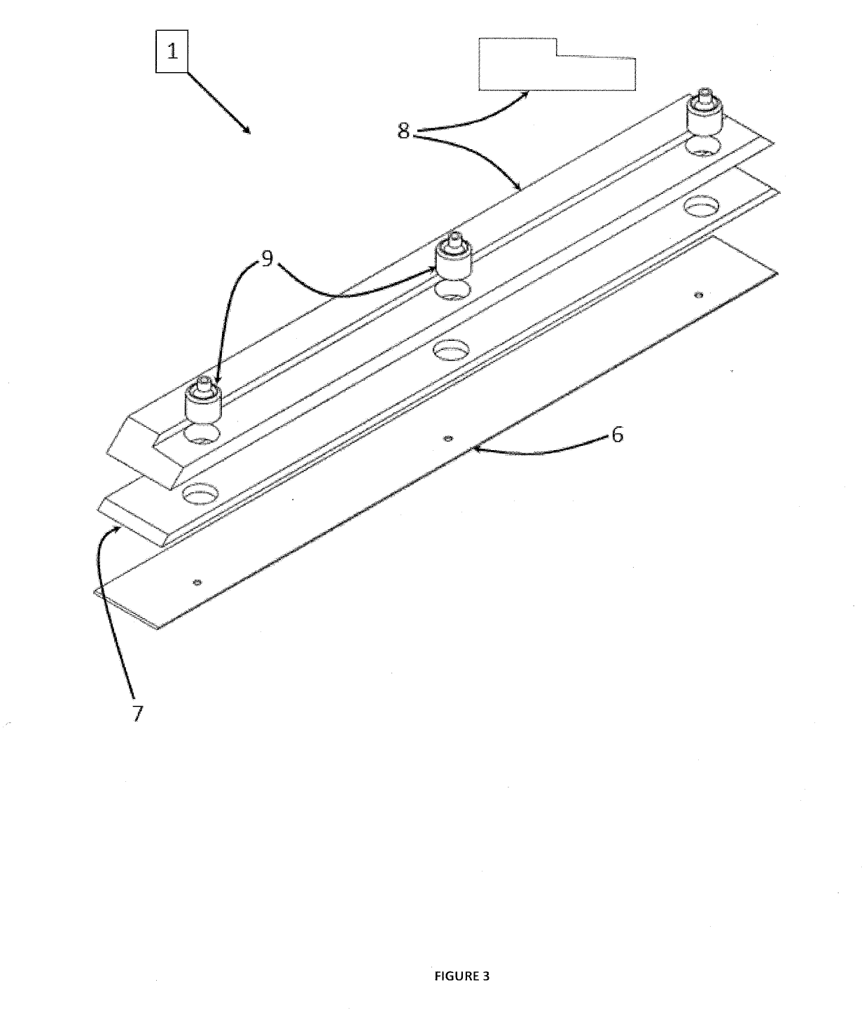

In the door frame, the jambs (1, 2) comprise a first rigid plate (6) which provides a support surface with the wall and which is mounted to an energy dissipation element (7) which in turn is mounted to a polygonal structural support (8), wherein one or more multidirectional energy dissipaters (9) are assembled perpendicularly to the elements (6), (7) and (8) (see FIG. 3).

In the integral door frame, the density of the energy dissipation element (7) is less than the density of the elements (6), (7) and (8) (see FIG. 3).

In the integral door frame, the polygonal structural support (8) has an angle of inclination greater than 90° at the contact area with the door (see FIG. 3).

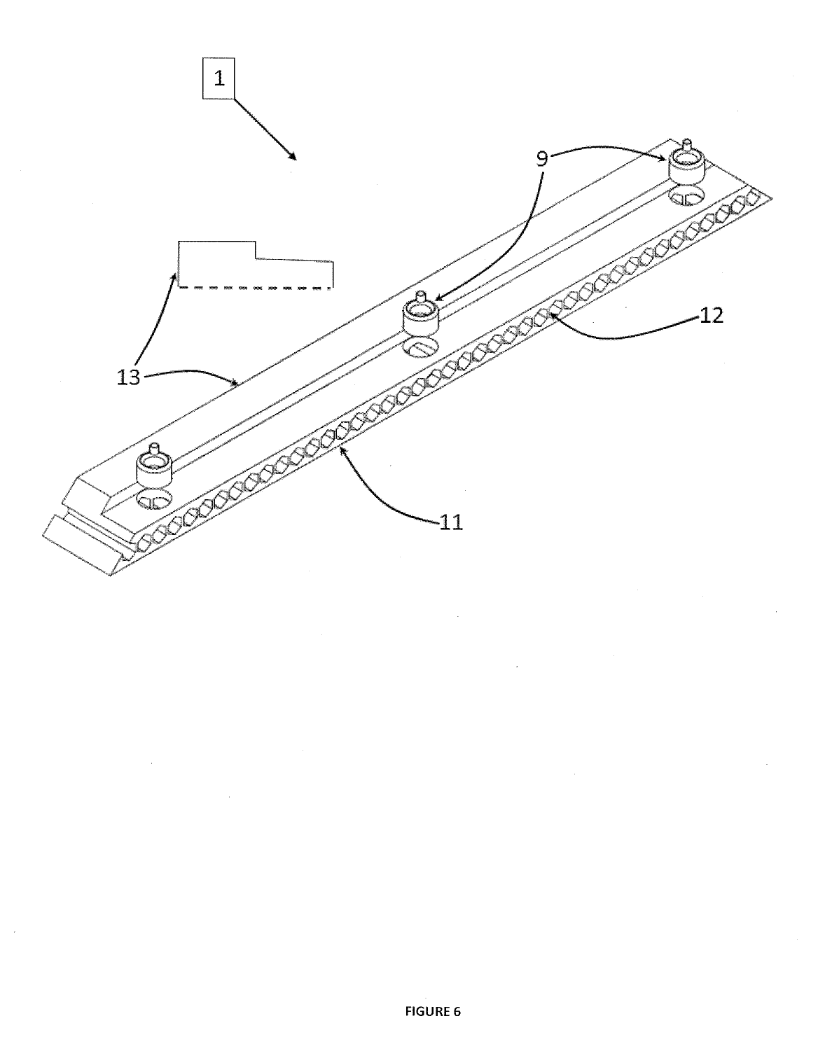

In the integral door frame, the jambs (1, 2) are configured as single injected pieces where there can be distinguished a wall contact zone (11), which provides a support surface with the wall, a load and energy dissipation zone (12) with polygonal interstices and a polygonal structural zone (13), wherein one or more multidirectional energy dissipaters (9) enable assembly to the wall (see FIG. 6).

In the integral door frame, the polygonal structural zone (13) has an angle of inclination greater than 90° at the contact area with the door (see FIG. 6).

In the integral door frame, the rigid plate (6) is made of metal, a metal alloy or a natural or synthetic polymer.

In the integral door frame, the energy dissipation element (7) is made of a natural or synthetic rubber, polymer or elastomer.

In the integral door frame, the polygonal structural support element (8) is made of wood, metal, a metal alloy or a natural or synthetic polymer.

In the integral door frame, the multidirectional energy dissipater (9) is made of a natural or synthetic rubber or elastomer.

In the integral door frame, the jambs (1, 2) are configured as single injected pieces made of a natural or synthetic rubber, elastomer or polymer.

When the head jamb (1) and side jambs (2) of the same length plus the parallelism correction element (3) between the head jamb (1) or the side jambs (2) and the wall (4), if required, are assembled together, an integral frame configuration is produced, capable of dissipating deformation and thus preventing obstruction of the door (5) (see FIG. 1).

### Head Jamb

The head jamb (1) is comprised by a first rigid plate (6), made either of wood, plastic, iron or a similar material, that provides a support surface with the wall and has some through-bores, equidistantly or irregularly spaced depending on the needs of its installation. The first rigid plate (6) is mounted to an energy dissipater (7) which has concentrically aligned bores with said latter bores. The head jamb (1) assembly then continues with a polygonal structural support element (8), made either of wood, plastic, iron or a similar material and which does not exclude curved configurations also, that provides rigidness to the assembly. Elements (6), (7) and (8) are physically joined together through chemical means, which can be an adhesive, thermo-chemical means such as vulcanization or a physical or mechanical means such as a screw, bushing or similar element in such a way as to maintain the joint for generating in this way proper functioning of energy dissipation altogether.

Further, the head jamb (1) can also be configured as a single injected piece, either made of a polymer, plastic or similar material, by making the densities, mechanical properties and bores of elements (6), (7) and (8) the same so as to form an energy dissipater or force damper. Such a head jamb (1) is comprised of: a first rigid zone (11), which is designed to provide a support surface with the wall, the same as element (6); while freedom of movement is allowed by means of a second zone (12) of polygonal geometric interstices designed to provide an even distribution of the stresses, the same as the energy dissipater (7), wherein the interstices contract or expand depending on the direction of the loads during an earthquake or due to seasonal climate changes or changes in relative humidity which expand or contract the door against the frame; and, the same as the polygonal structural support element (8), a third polygonal structural rigid zone (13), which in its shape can have or not an angle greater than 90° at the area of contact with the door to reduce direct friction.

The head jamb (1) carries a multidirectional energy dissipater (9) physically and perpendicularly joined to the polygonal structural support element (8) through chemical means, which can be an adhesive, or through thermo-chemical means such as vulcanization, or else joined to the polygonal structural rigid zone (13) through a bore of the same diameter and concentric with the other bores, enabling the multidirectional energy dissipater (9) to respectively make contact with the energy dissipating element (7) or the second zone (12) of polygonal geometric interstices and operate to dissipate structural deformations in other degrees. As a result it prevents loading on the attachment to the wall and gives the polygonal structural support element (8) or polygonal structural rigid zone (13) freedom to move 360° and in all the combinations of the X, Y and Z Cartesian planes. At its longitudinal axis the multidirectional energy dissipater (9) has a bushing (10) inserted, which is an essential central reinforcement that permits anchoring the head jamb (1) to the wall, enabling dissipation of the loads over the anchorage and not rigidizing the whole (See FIGS. 3, 5 and 6).

### Side Jamb

The side jamb (2) is comprised by a first rigid plate (6), made either of wood, plastic, iron or a similar material, that provides a support surface with the wall and has some through-bores, equidistantly or irregularly spaced depending on the needs of its installation. The first rigid plate (6) is mounted to an energy dissipater (7) which has concentrically aligned bores with said latter bores. The head jamb (1) assembly then continues with a polygonal structural support element (8), made either of wood, plastic, iron or a similar material and which does not exclude curved configurations also, that provides rigidness to the assembly. Elements (6), (7) and (8) are physically joined together through chemical means, which can be an adhesive, thermo-chemical means such as vulcanization or a physical or mechanical means such as a screw, bushing or similar element in such a way as to maintain the joint for generating in this way proper functioning of energy dissipation altogether.

Further, the side jamb (2) can also be configured as a single injected piece, either made of a polymer, plastic or similar material, by making the densities, mechanical properties and bores of elements (6), (7) and (8) the same so as to form an energy dissipater or force damper. Such a side jamb (2) is comprised of: a first rigid zone (11), which is designed to provide a support surface with the wall, the same as element (6); while freedom of movement is allowed by means of a second zone (12) of polygonal geometric interstices designed to provide an even distribution of the stresses, the same as the energy dissipater (7), wherein the interstices contract or expand depending on the direction of the loads during an earthquake or due to seasonal climate changes or changes in the relative humidity which expand or contract the door against the frame; and, the same as the polygonal structural support element (8), a third polygonal structural rigid zone (13), which in its shape can have or not an angle greater than 90° at the area of contact with the door to reduce direct friction.

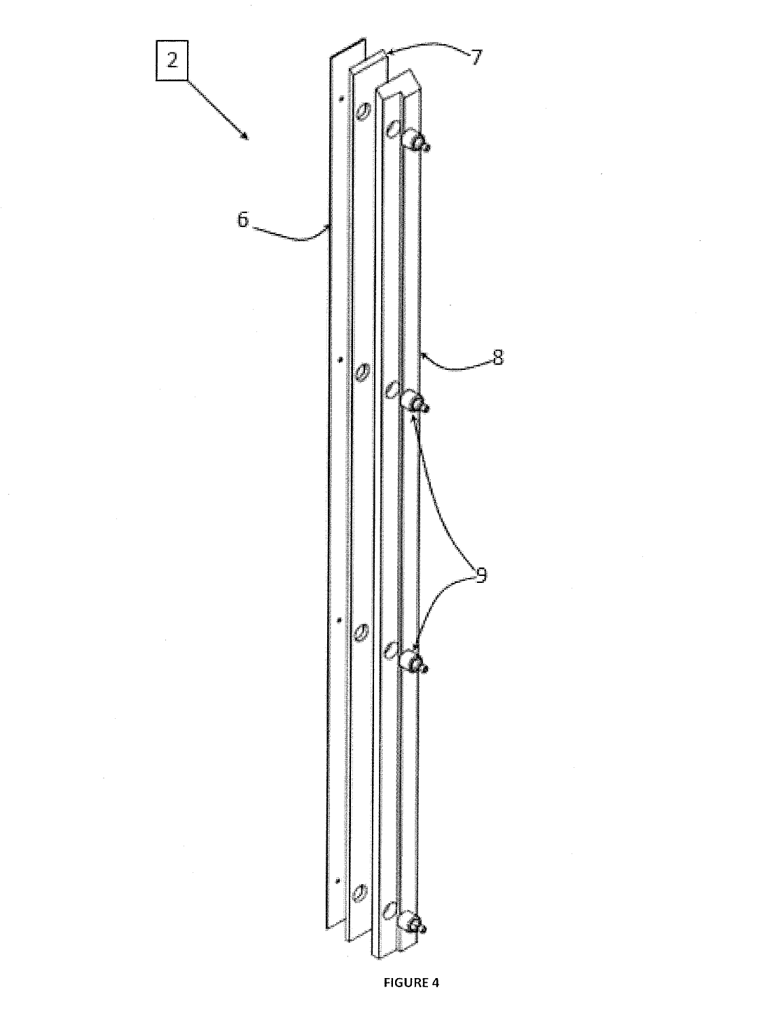

The side jamb (2) carries a multidirectional energy dissipater (9) physically and perpendicularly joined to the polygonal structural support element (8) through chemical means, which can be an adhesive, or through thermo-chemical means such as vulcanization, or else joined to the polygonal structural rigid zone (13) through a bore of the same diameter and concentric with the other bores, allowing the multidirectional energy dissipater (9) to respectively make contact with the energy dissipating element (7) or the second zone (12) of polygonal geometric interstices to and operate to dissipate structural deformations in other degrees. As a result it prevents loading on the attachment of the jamb to the wall and gives the polygonal structural support element (8) or polygonal structural rigid zone (13) freedom to move 360° and in all the combinations of the X, Y and Z Cartesian planes. At its longitudinal axis the multidirectional energy dissipater (9) has a bushing (10) inserted, which is an essential central reinforcement that permits anchoring the side jamb (2) to the wall, enabling dissipation of the loads over the anchorage and not rigidizing the whole (See FIGS. 4, 5 and 7).

### Parallelism Correction Element

The wall parallelism correction element (3) is an independent element that is installed between the wall and the head jamb (1) or side jambs (2) of the same length and which can be made of wood, plastic, iron or similar material with guiding through-bores which are equidistantly or irregularly spaced, depending on the needs, and are concentrically aligned with the side jamb (1, 2) anchoring perforations. This allows correction of variations in the perpendicularity of the walls, providing a correct installation without affecting the aforementioned mechanical and energy dissipation properties. Another characteristic is that to correct larger variations several of these elements can be superimposed (see FIG. 8).

1. Integral antiseismic door frame of seismic shock dissipation, CHARACTERIZED in that it comprises a head jamb (1) and two side jambs (2) of the same length which control the movements and loads exerted by the wall on the door.

2. The integral door frame according to claim 1, CHARACTERIZED in that the jambs (1, 2) have one or more parallelism correction elements.

3. The integral door frame according to claim 1, CHARACTERIZED in that the multidirectional energy dissipater (9) has a bushing located at its longitudinal axis.

4. The integral door frame according to claim 1, CHARACTERIZED in that the jambs (1, 2) comprise a first rigid plate (6) which provides a support surface with the wall and which is mounted to an energy dissipation element (7) which in turn is mounted to a polygonal structural support (8), wherein one or more multidirectional energy dissipaters (9) are assembled perpendicularly to the elements (6), (7) and (8).

5. The integral door frame according to claim 1, CHARACTERIZED in that the density of the material of the energy dissipation element (7) is less than the density of the elements (6) and (8).

6. The integral door frame according to claim 1, CHARACTERIZED in that the polygonal structural support (8) has an angle of inclination greater than 90° at the contact area with the door.

7. The integral door frame according to claim 1, CHARACTERIZED in that the jambs (1, 2) are configured as a single injected piece where there can be distinguished a wall contact zone (11), which provides a support surface with the wall, a load and energy dissipation zone (12) with polygonal interstices and a polygonal structural zone (13), wherein one or more multidirectional energy dissipaters (9) enable assembly to the wall.

8. The integral door frame according to claim 7, CHARACTERIZED in that the polygonal structural zone (13) has an angle of inclination greater than 90° at the contact area with the wall.

9. The integral door frame according to claim 4, CHARACTERIZED in that the rigid plate (6) is made of metal, a metal alloy or a natural or synthetic polymer

10. The integral door frame according to claim 4, CHARACTERIZED in that the energy dissipation element (7) is made of a natural or synthetic rubber, polymer or elastomer.

11. The integral door frame according to claim 4, CHARACTERIZED in that the polygonal structural support element (8) is made of wood, metal, a metal alloy or a natural or synthetic polymer.

12. The integral door frame according to claim 3, CHARACTERIZED in that the multidirectional energy dissipater (9) is made of a natural or synthetic rubber or elastomer.

13. The integral door frame according to claim 7, CHARACTERIZED in that the jambs (1, 2) are configured as single injected pieces made of a natural or synthetic rubber, elastomer or polymer.
